(19) United States
(12) Patent Application Publication
(10) Pub. No.: US 2008/0260197 A1
(43) Pub. Date: Oct. 23, 2008

(54) Adjustable earhook

(76) Inventor: Fred I. Polito, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(21) Appl. No.: 11/027,364

(22) Filed: Dec. 30, 2004

(51) Int. Cl. H04R 1/10; H04R 25/00

(52) U.S. Cl. 381/381; 381/361

(57) ABSTRACT

An earhook adapted to fit on a user ear. In an embodiment of the invention, the earhook includes a first portion having a fixed first curvature and a second portion having an adjustable second curvature for grasping a user ear. The second portion may be adjustably coupled together with the first portion with a coupling mechanism so that the second curvature is adjusted to suit a user preference.

### TECHNICAL FIELD

The present invention relates to the general field of audio devices. More specifically the invention relates to earhooks utilized with audio devices.

### BACKGROUND

Communication headsets can be used in a diversity of applications and are particularly effective for telephone operators, radio operators, aircraft personnel, and for other individuals for whom it is desirable to have hands-free operation of communication systems. Accordingly, a wide variety of headsets are known in the prior art. Such headsets are often implemented with an earhook that fits around the ear to secure the audio device in place.

Audio devices, such as those used in communication devices, intended to be worn on the ear tend to be unstable when worn. Due to the large natural variation in the size, shape, and orientation of human ears, over-the-ear style earhook headsets often do not fit properly. In particular, prior art earhooks are often not stable, i.e. do not fit snugly, and are not comfortable across a large spectrum of potential users.

Additionally, many products are difficult to put on because of counterintuitive designs. Typically, such audio products utilizing earhooks (also referred to as earloops) are one-size and pose difficulties in finding methods of adjustment that provide good fit and comfort with a variety of ear sizes and shapes.

Prior art solutions utilize mechanical hinges or embedded wiring to accomplish adjustments. In the prior art, earhooks use flexing or hinging flippers or loops to stabilize audio devices on the ear. Some previously known earhook solutions have used hard, extendible pieces to lengthen the earhook behind the ear lobe. Others have used small, pivotable flippers to close the gap behind the ear. However, these earhooks typically have fixed contours with limited or no predetermined ranges of motion and shapes that fit only a limited population of users. Consequently, they are not comfortable for many users and do not provide a secure fit.

Other known earhook solutions employ molded, rubber-like material, either alone or reinforced with metal wire inserts. Unfortunately, the rubber earhooks often stretch during use, allowing the earhook to slide or rotate about the ear. Moreover, wire reinforced designs often fatigue and break with continuous use, reducing the useful life of the headset. Removing the installed earhook usually distorts its previous wearing shape and requires the user to reshape the earhook each time that it is worn.

Accordingly, there is a need for improved earhooks that are suitable for a wide variety of ear shapes, sizes, and orientations.

### SUMMARY OF THE INVENTION

The present invention provides a solution to the needs described above through an inventive adjustable earhook.

The present invention provides an earhook adapted to fit on a user ear. In an embodiment of the invention, the earhook includes a first portion having a fixed first curvature and a second portion having an adjustable second curvature for grasping a user ear. The second portion may be adjustably coupled together with the first portion with a coupling mechanism so that the second curvature is adjusted to suit a user preference.

The present invention further provides for an earhook adapted to fit on a user ear including a first portion having a fixed first curvature and a first coupling component, and a second portion having an adjustable second curvature and a second coupling component. The first coupling component and the second coupling component may be adjustably coupled together with the first portion so that the second curvature is adjusted to suit a user preference.

The present invention further provides for a method for adjusting an earhook, the earhook including a first portion having a fixed first curvature coupled to a second portion having an adjustable second curvature for grasping a user ear. The method includes modifying the extent of coupling between the first portion and the second portion so that the adjustable second curvature either matches or deviates from the fixed first curvature to suit a user preference.

### DESCRIPTION OF THE DRAWINGS

The features and advantages of the apparatus and method of the present invention will be apparent from the following description in which:

FIG. 1 illustrates an embodiment of the earhook of the present invention in a first use position.

FIG. 2 illustrates an embodiment of the earhook of the present invention in a second use position.

FIG. 3 illustrates a disassembled view of the components of an embodiment of the earhook of the present invention.

FIG. 4 illustrates a further embodiment of the earhook of the present invention.

FIG. 5 illustrates a disassembled view of the components of the earhook illustrated in FIG. 4.

### DETAILED DESCRIPTION OF THE PREFERRED EMBODIMENTS

The present invention provides a solution to the needs described above through an inventive system and method for an adjustable earhook.

Other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

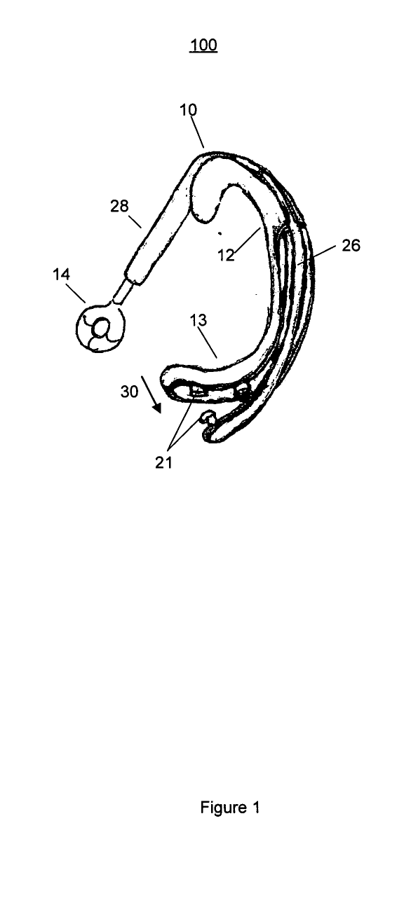

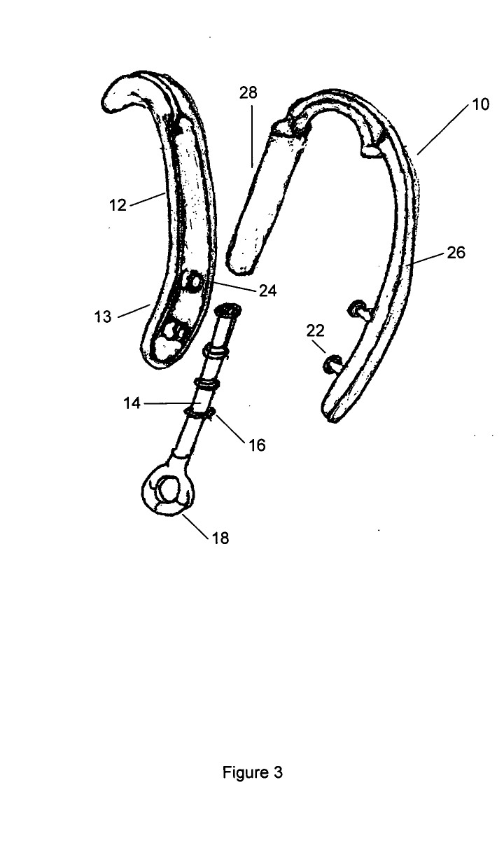

The present invention provides an adjustable earhook that is suitable for a wide variety of ear shapes, sizes, and orientations. FIG. 1 illustrates an embodiment of the invention in a first use position. Referring to FIG. 1, there is illustrated an earhook 100 in a substantially uncoupled configuration. Referring to FIG. 3, a disassembled view of the components of earhook 100 is shown.

In one embodiment, earhook 100 includes a jelly loop 12 adapted to curve at least partially around and behind the ear. As shown in FIG. 1, jelly loop 12 may have an arcuate or crescent shape to conveniently wrap around and securely grasp the ear, although other configurations are possible. In one embodiment, jelly loop 12 is formed using commercially available soft and pliable elastomeric jelly skin or foam composite skin, both of which are well known to those skilled in the art. For example, jelly loop 12 may consist of talc coated silicone or composite materials with foam and various injection molded elastomerics. It should be recognized, however, that many different materials with similar properties could be used within the scope of the present invention. The jelly loop 12 provides sufficient rigidity for exerting clamping pressure against the ear, as described in greater detail below. Jelly loop 12 is composed of a material that provides a contact surface providing comfort and allowing the jelly loop 12 to conform to the shape of the ear.

Earhook 100 further includes spine 10. In one embodiment of the invention, spine 10 includes an arcuate segment 26 and linear segment 28. Spine 10 is adapted to curve at least partially around and behind the ear. As shown in FIG. 1, spine 10 includes an arcuate segment 26 with a flatter or lower degree of curvature than that of jelly loop 12. In one embodiment, spine 10 is formed using a polypropylene material. One of ordinary skill in the art will recognize that additional material with similar properties to polypropylene may be used. Arcuate segment 26 is not intended to fit the user ear directly and is therefore designed with a fixed curvature. Referring to FIG. 1, jelly loop 12 is coupled to arcuate segment 26 at a fixed point near the upper end of the earhook 100 in proximity to the intersection of arcuate segment 26 and linear segment 28 of spine 10.

Jelly loop 12 is flexible within the plane of the earhook 100 and is resiliently biased in the direction of the ear to return to an initial resting state after being stretched and released. Jelly loop 12 provides clamping pressure to firmly grasp the user ear. As described further below, jelly loop 12 may be stretched in a direction indicated by arrow 30 in FIG. 1. Such stretching is also referred to herein as opening the jelly loop in opposition to the resilient bias. The extent of jelly loop 12 coupled to spine 10 is held in an open position. When released from spine 10, jelly loop 12 automatically returns to its resting uncoupled position, also referred to herein as a closed or unstretched state. Spine 10 is sufficiently rigid so that it does not deform when coupled to jelly loop 12.

An advantage of the invention is that jelly loop 12 may be held open at one or more use positions, allowing jelly loop 12 and earhook 100 to be adjusted to fit a variety of users and ear sizes. Depending on the coupling mechanism between jelly loop 12 and spine 10, the user positions may either be predetermined discrete positions or adjustable along a continuum.

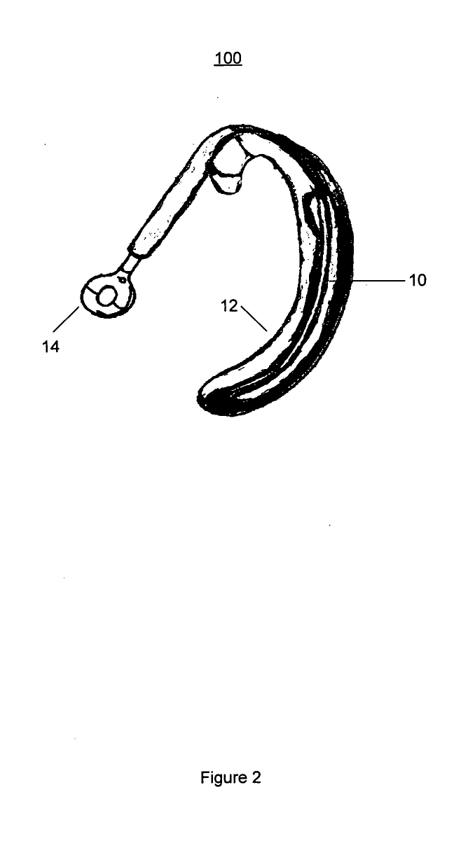

Referring to FIG. 2 with components illustrated by exemplary FIGS. 1 and 3, an embodiment of the invention in a second use position is illustrated. FIG. 2 illustrates earhook 100 with jelly loop 12 stretched and held in a maximum open position. In the maximum open position, the lower end of jelly loop 12 is held at an open position matching the curvature of spine 10. Jelly loop 12 is held open by coupling mechanism 21 comprising coupling component 24 of jelly loop 12 and coupling component 22 of spine 10. Jelly loop 12 may be progressively coupled to spine 10 and held in a progressively more open position to accommodate a wide variety of users.

Referring to FIG. 3, spine 10 includes a linear segment 28 serving as a stem tube adapted to receive an adjustable stem 14. In one embodiment, adjustable stem 14 is formed using commercially available ABS or other sufficiently rigid material, all of which are well known to those skilled in the art. In one embodiment of the invention, adjustable stem 14 is attached with friction force to a headset audio receiver/transmitter assembly.

Adjustable stem 14 includes a component 18 of a joining mechanism such as a ball joint for coupling adjustable stem 14 to an audio receiver/transmitter assembly. The audio receiver/transmitter assembly will typically include a boom microphone. Audio receiver/transmitters are widely available in the art, such as the receiver/transmitters used in a variety of headsets available from Plantronics, Inc. of Santa Cruz, Calif., although other receiver/transmitters could be used without departing from the spirit of the invention.

Although an embodiment has been discussed herein describing a receiver/transmitter assembly, earhook 100 of the present invention may be utilized with other electronic devices. For example, earhook 100 may be used with a receiver element without a transmitter element for applications that do not require an audio transmitter. Alternatively, the earhook may be coupled to a transmitter element without the receiver.

Adjustable stem 14 may be rotated within linear segment 28 and the audio receiver/transmitter assembly can be desirably rotated about adjustable stem 14 to allow the user to rotate the audio receiver/transmitter assembly in order selectively position the receiver component near the user's ear canal and the transmitter near the user's mouth. Adjustable stem 14 includes one or more ridges 16 that function as height adjustment stops when adjustable stem 14 is inserted into linear segment 28. Linear segment 28 includes one or more grooves (not shown) that receive corresponding ridges 16 to lock adjustable stem 14 in place at the desired position. In an embodiment of the invention, adjustable stem 14 includes three ridges 16 corresponding to small, medium, and large use positions.

In operation, referring to FIGS. 1 and 3, a user applied force shown by arrow 30 opposing the resilient bias is applied to coupling end 13 of jelly loop 12 to stretch open the jelly loop 12. Jelly loop 12 is coupled to spine 10 at a desired use position by mating coupling component 24 with coupling component 22. When the user releases coupling end 13, coupling mechanism 21 opposes the resilient bias force of the jelly loop and jelly loop 12 is held open in the desired position. As illustrated in FIG. 1, coupling mechanism 21 may allow for multiple use positions, allowing jelly loop 12 to be held in open states of varying curvature.

In operation, when a user desires to adjust earhook 100 to a user position corresponding to a smaller use position, the user grasps coupling end 13 and disengages jelly loop 12 from spine 10. When coupling mechanism 21 is disengaged, the resilient bias of jelly loop 12 returns jelly loop to it's natural closed state, as shown in FIG. 1.

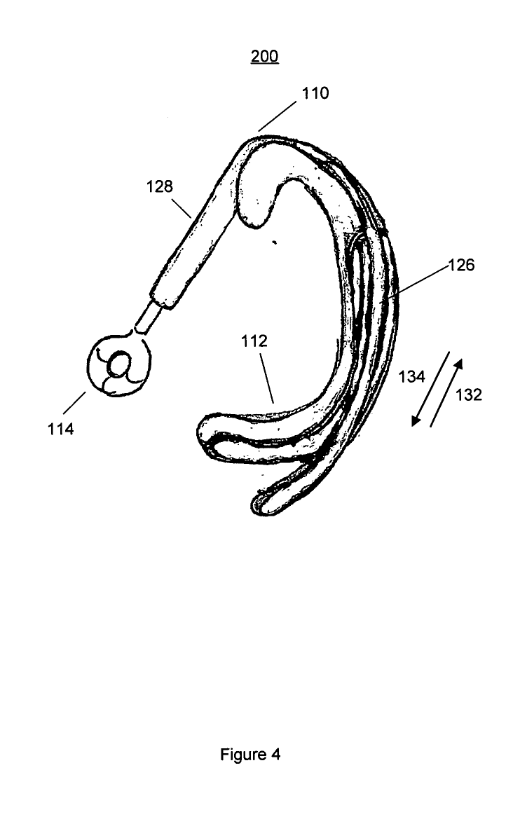

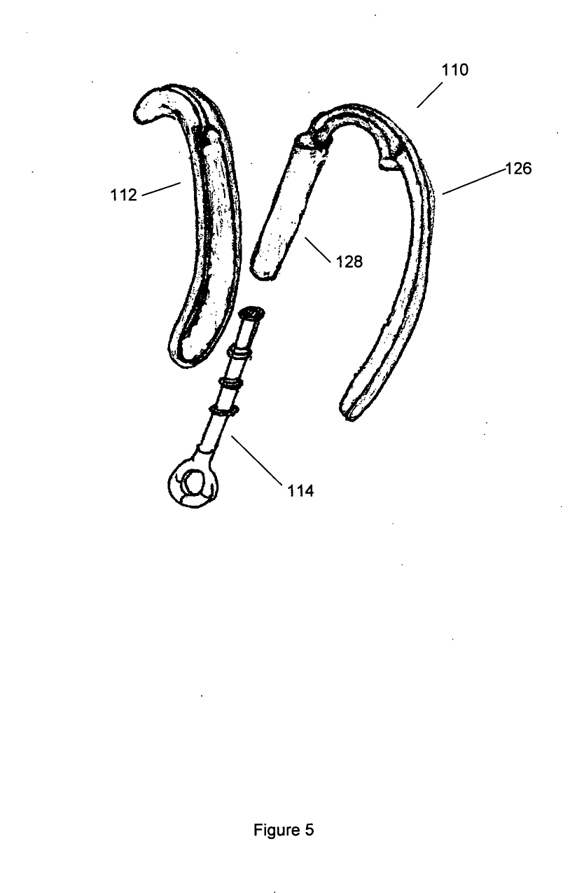

In an embodiment of the invention, coupling component 22 are one or more male snap components formed on spine 10. Coupling component 24 on jelly loop are female snap components which receive the male snap components as desirably coupled or uncoupled by the user. The précising coupling means between jelly loop 12 and spine 10 may vary in further embodiments of the invention. The use of male and female snap components may be supplemented with a press and fit seal, as illustrated in FIG. 1. However, the male and female snap components may also be utilized as the sole coupling mechanism. In a further embodiment of the invention, a press and fit seal coupling mechanism without the male and female snaps is described below in reference to FIGS. 4 and 5.

In operation, a user may adjust the position of an audio receiver/transmitter by moving adjustable stem 14. The user may insert adjustable stem 14 into linear segment 28 to varying degrees depending upon user preference and ear size. In an embodiment of the invention, adjustable stem 14 has pre-determined use positions defined by ridges 16 and associated mating grooves in linear segment 28. One of ordinary skill in the art will recognize that other coupling mechanisms may be utilized to hold fix adjustable stem 14 in linear segment 28 in an adjustable manner.

In one embodiment, the jelly loop 12 can flex or twist orthogonally to the regular plane of the earhook 100 in response to torsion, and the jelly loop 12 is resiliently biased to return when the torsion is removed. The ability to flex out-of-plane allows the jelly loop 12 to conform to a multi-plane contour of the head around the ear, allowing the earhook 100 to be worn comfortably and securely by a greater number of users.

In operation, the adjustable clamping positions imposed by the jelly loop 12 allows the ear loop 100 to selectively compress and expand in different use positions to conform to the individual contours of the user's ear, snugly and securely grasping the ear to provide stability, correct sizing, and comfort. Thus, the earhook 100 of the present invention may be comfortably and securely worn by a wide variety of users with different ear sizes and shapes, thereby avoiding the instability, sizing, difficulty of use, or other problems so prevalent with conventional earhooks.

FIGS. 4 and 5 illustrate an earhook 200 representing a further embodiment of the invention utilizing only a press and fit seal between a jelly loop 112 and a spine 110. Referring to FIG. 5, a disassembled view of the components of earhook 200 are shown. Earhook 200 includes a jelly loop 112, spine 110, and adjustable stem 114. Spine 110 includes an arcuate segment 126 and a linear segment 128. Jelly loop 112, spine 110, and adjustable stem 114 are formed of materials similar to that as described above. Except as described below with respect to the coupling mechanism, jelly loop 112, spine 110, and adjustable stem 114 function in a manner similar to that as described above.

Referring to FIG. 4, jelly loop 112 is coupled to arcuate segment 126 at a fixed coupling point near the intersection of arcuate segment 126 and linear segment 128 of spine 110. Spine 110 is sufficiently rigid so that it does not deform when coupled to jelly loop 112.

In operation, jelly loop 112 and spine 110 form the components of a press-and-fit type seal. Arcuate segment 126 of spine 110 forms the male component of the press-and-fit seal and jelly loop 112 includes a groove shaped channel serving as the female component. Jelly loop 112 and spine 110 may be releasably joined to varying lengths by mating the spine 110 with the groove shaped channel of the jelly loop 112. The extent of mating can be varied based upon user preference. As the press-and-fit seal is extended away from the fixed coupling point in a direction indicated by arrow 134, jelly loop 112 is extendibly coupled to spine 110 and held in a progressively more open position to accommodate a wide variety of users.

When the press-and-fit seal between jelly loop 112 and spine 110 is complete, jelly loop 112 is stretched and held in a maximum open position. When a user desires to adjust earhook 200 to a user position corresponding to a smaller ear, the user grasps jelly loop 112 and progressively disengages the press-and-fit seal in a direction indicated by arrow 132. Upon release by the user, portions of the jelly loop 112 disengaged from the press-and-fit seal return to the natural closed state due to the resilient bias of jelly loop 112.

In a further embodiment, a slider or other actuator mechanism may be utilized for initiating the joining and releasing of jelly loop 112 and spine 110. The slider is moved in a seal direction 134 to initiate joining jelly loop 112 and spine 110 in a press and fit seal. The slider is moved in a release direction 132 to separate the joined jelly loop 112 and spine 110, releasing the press-and-fit seal and allowing jelly loop 112 to return to it's naturally biased closed state.

Jelly loop 112 and spine 110 may be adjustably coupled using a variety of coupling mechanisms in addition to those described herein. Although embodiments have been discussed herein describing snap connectors and a press and fit seal, the earhook of the present invention may utilize a variety of adjustable coupling mechanisms. For example, jelly loop 112 and spine 110 could also be adjustably coupled using a zipper-style coupling mechanism.

Thus, the earhook of the present invention provides improved adjustability, comfort, stability and fit. One of ordinary skill in the art will recognize that other architectures may be used for adjustably coupling the jelly loop to the spine. Furthermore, other architectures may be employed for adjustably coupling an audio device to the earhook.

Having described the invention in terms of a preferred embodiment, it will be recognized by those skilled in the art that various types of components may be substituted for the configuration described above to achieve an equivalent result. It will be apparent to those skilled in the art that modifications and variations of the described embodiments are possible, and that other elements or methods may be used to perform equivalent functions, all of which fall within the true spirit and scope of the invention as measured by the following claims.

1. An earhook adapted to fit on a user ear comprising:
a first portion having a fixed first curvature; and
a second portion having an adjustable second curvature for grasping a user ear, wherein the second portion may be adjustably coupled together with the first portion with a coupling mechanism so that the second curvature is adjusted to suit a user preference.

2. The earhook of claim 1, wherein the second portion comprises an elastomeric jelly skin.

3. The earhook of claim 1, wherein the second portion is crescent shaped.

4. The earhook of claim 1, wherein the adjustable second curvature has a resting state that may be modified upon a user applied force and held by the coupling mechanism, and wherein the second portion has a resilient bias such that the adjustable second curvature returns to the resting state when disengaged from the coupling mechanism.

5. The earhook of claim 1, wherein the second portion exerts a clamping pressure against the user ear.

6. The earhook of claim 1, wherein the second portion comprises a foam composite skin.

7. The earhook of claim 1, wherein the second portion comprises talc coated silicone.

8. The earhook of claim 1, wherein the first portion comprises a polypropylene material.

9. The earhook of claim 1, wherein the fixed first curvature is less than the adjustable second curvature.

10. The earhook of claim 1, wherein the first portion further comprises a linear segment.

11. The earhook of claim 10, wherein the linear segment comprises a hollow tubular member.

12. The earhook of claim 11, further comprising:
a stem having a first end for coupling to an audio device and a second end for adjustably inserting the stem to varying lengths into the hollow tubular member.

13. The earhook of claim 12, wherein the audio device is a boom microphone receiver/transmitter assembly.

14. The earhook of claim 12, wherein the stem comprises one or more stops in proximity to the second end and the hollow tubular member comprises one or more interior grooves for mating with the stops.

15. The earhook of claim 12, wherein the stem comprises three stops corresponding to small, medium, and large use positions.

16. The earhook of claim 12, wherein the stem is rotatable within the hollow tubular member.

17. The earhook of claim 1, wherein the first portion is fixedly coupled to the second portion.

18. The earhook of claim 1, wherein the first portion and second portion form the components of a press-and-fit seal.

19. The earhook of claim 18, further comprising a slider capable of bi-directional movement along the first portion and second portion, wherein the slider actuates sealing and releasing of the press and fit seal.

20. An earhook adapted to fit on a user ear comprising:
a first portion having a fixed first curvature and a first coupling component; and
a second portion having an adjustable second curvature and a second coupling component, wherein the first coupling component and the second coupling component may be adjustably coupled together so that the second curvature is adjusted to suit a user preference.

21. The earhook of claim 20, wherein the first coupling component comprises one or more male connectors disposed along the first portion and the second coupling component comprises one or more female connectors disposed along the second portion.

22. The earhook of claim 21 comprising a first male/female connector pair corresponding to a maximum open position and a second male/female connector pair corresponding to an intermediary open position.

23. The earhook of claim 20, wherein the first coupling component is a male snap connector and the second coupling component is a female snap connector.

24. The earhook of claim 20, further comprising:
a stem with one or more adjustment stops disposed along its length, wherein a first end of the stem may be adjustably inserted into the first portion to suit a user preference and a second end of the stem is adapted to couple to an audio device.

25. The earhook of claim 24, wherein the audio device is a boom microphone receiver/transmitter assembly.

26. The earhook of claim 24, wherein the stem comprises three stops corresponding to small, medium, and large use positions.

27. The earhook of claim 24, wherein the stem is rotatable within the hollow tubular member.

28. The earhook of claim 20, wherein the first portion is fixedly coupled to the second portion.

29. The earhook of claim 20, wherein the second portion comprises an elastomeric jelly skin.

30. The earhook of claim 20, wherein the second portion is crescent shaped.

31. The earhook of claim 20, wherein the adjustable second curvature has a resting state that may be modified upon a user applied force and held by mating the first coupling component and the second coupling component, and wherein the second portion has a resilient bias such that the adjustable second curvature returns to the resting state when the first coupling component and second coupling component are disengaged.

32. The earhook of claim 20, wherein the second portion exerts a clamping pressure against the user ear.

33. The earhook of claim 20, wherein the second portion comprises a foam composite skin.

34. The earhook of claim 20, wherein the second portion comprises talc coated silicone.

35. The earhook of claim 20, wherein the first portion comprises a polypropylene material.

36. The earhook of claim 20, wherein the fixed first curvature is less than the adjustable second curvature.

37. The earhook of claim 20, wherein the first portion further comprises a linear segment.

38. The earhook of claim 37, wherein the linear segment comprises a hollow tubular member.

39. A method for adjusting an earhook, the earhook comprising a first portion having a fixed first curvature coupled to a second portion having an adjustable second curvature, the method comprising:
modifying the extent of coupling between the first portion and the second portion so that the adjustable second curvature matches or deviates from the fixed first curvature to suit a user preference.

40. The method of claim 39, wherein the second portion having an adjustable second curvature has a resilient bias, the method further comprising:
returning the second curvature to an uncoupled curvature automatically due to the resilient bias by decreasing the extent of coupling between the first portion and the second portion.

41. The method of claim 39, wherein the first portion further comprises a tube for receiving a stem coupled to an audio device, the method further comprising:
adjustably positioning the stem within the tube to suit a user preference.

42. An earhook adapted to fit on a user ear comprising:
a first portion having a fixed first curvature; and
a second portion having an adjustable second curvature for grasping a user ear;
a coupling means for adjustably coupling the second portion with the first portion so that the second curvature is adjusted to suit a user preference.

43. The earhook of claim 42, wherein the first portion further comprises a height adjustable attachment means for coupling the earhook to an audio device.
